(19) United States
(12) Patent Application Publication
(10) Pub. No.: US 2013/0258198 A1
(43) Pub. Date: Oct. 3, 2013

(54) VIDEO SEARCH SYSTEM AND METHOD

(71) Applicant: JIE LIU, Shenzhen City (CN)

(72) Inventor: JIE LIU, Shenzhen City (CN)

(21) Appl. No.: 13/664,447

(22) Filed: Oct. 31, 2012

(30) Foreign Application Priority Data
Mar. 28, 2012 (CN) 201210085353.7

(51) Int. Cl. H04N 9/74

(52) U.S. Cl. 348/578; 348/E05.056

(57) ABSTRACT

A video search method includes: displaying an input interface; building a model image as the key image according to at least one input parameters if at least one parameter is input through the input interface; extracting information as to features of the key image; comparing the features of the key image with features in each frame of each stored video file to determine whether the features shown in one or more frames of each stored video file match with the features of the key images; determining that a video file is a target video file if at least one frame of the video file matches with the features of the key image; and presenting the target video files or other processing. A computing device and a storage medium for searching video files are also described.

### BACKGROUND

1. Technical Field

The present disclosure relates to search systems, and particularly, to a video search system and a search method.

2. Description of Related Art

Searching for a target video file from a number of video files is often done visually by a user. For example, if a user wants to search for a video file which may include the image of a lost child from video files recorded by video cameras arranged on the streets the lost child may have passed through, the user may have to look through all of the video files, which is time-consuming.

Therefore, what is needed is a means to solve the above mentioned problem.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the several views.

FIG. 1 is a block diagram of a computing device, in accordance with an exemplary embodiment.

FIG. 2 is a block diagram of a video search system, in accordance with an exemplary embodiment.

FIG. 3 is a schematic view of an input interface provided by the video search system of FIG. 2, in accordance with an exemplary embodiment.

FIG. 4 is a flowchart of a video search method, in accordance with an exemplary embodiment.

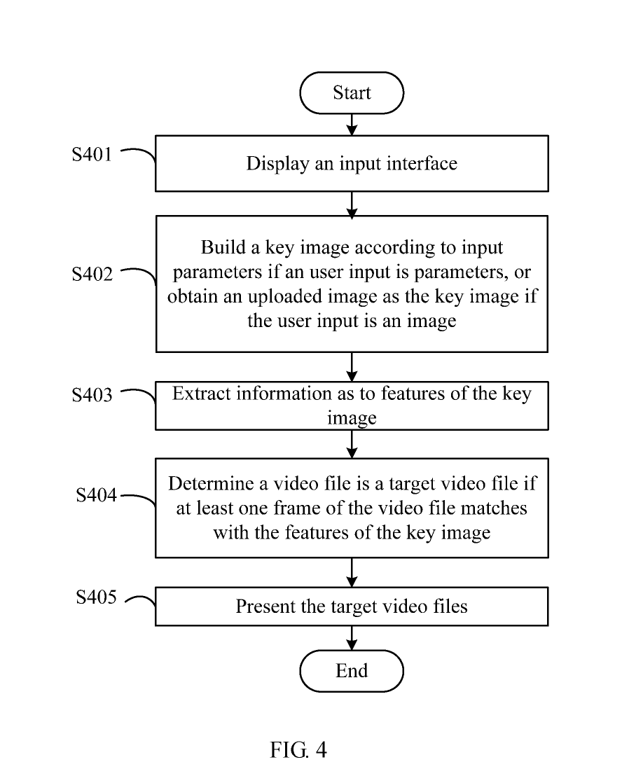

### DETAILED DESCRIPTION

Embodiments of the present disclosure will be described with reference to the accompanying drawings.

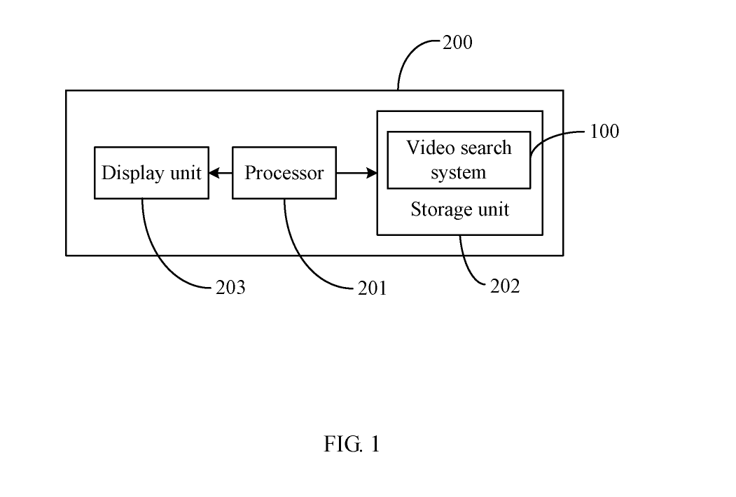

Referring to FIGS. 1-3, in one embodiment, a video search system 100 applied in a computing device 200 is illustrated. The computing device 200 includes a processor 201, a storage unit 202, and a display unit 203. The storage unit 202 stores computerized codes of the video search system 100. The video search system 100 includes various software components and/or sets of instructions, which may be implemented by the processor 201 to search for one or more target video files in a local or remote database using a key image. In this embodiment, the key images for video searching are two-dimensional images.

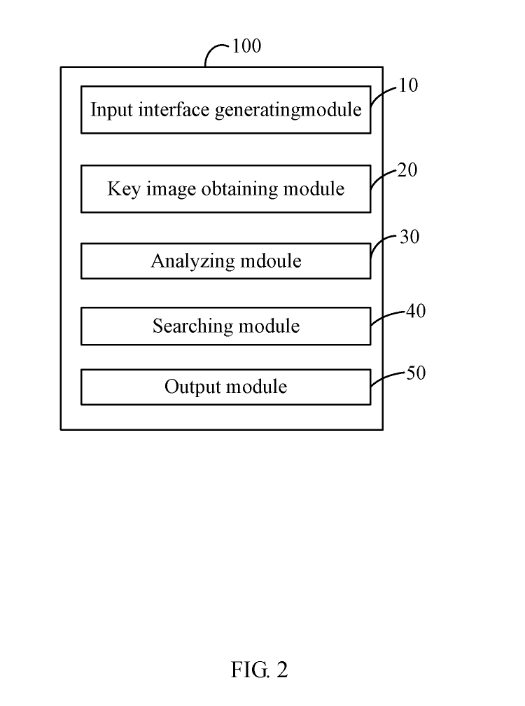

FIG. 2 is a block diagram of function modules of the video search system 100 in the computing device 200 of FIG. 1. In one embodiment, the video search system 100 includes an input interface generating module 10, a key image obtaining module 20, an extracting module 30, a searching module 40, and a target video file processing module 50.

The input interface generating module 10 includes various software components and/or sets of instructions, which may be implemented by the processor 201 to display an input interface 101 on the display unit 203. The interface 101 includes an image input field 1011 and a parameter input field 1012. The image input field 1011 is configured for a user to upload an image as a key image for video files searching. In this embodiment, the key images uploaded by the user may be from a local or remote computer, a camera, and the like. The parameter input field 1012 is configured for the user to input parameters used in building a key image. In this embodiment, the parameter input field 1012 may include a number of windows for the user to input different parameters, for example, the input parameters may be parameters of a human body, such as the color of skin or color of clothes of the human, the height of the human, and body features of the human, for example lame, hunchbacked, and the like. In this embodiment, the parameter input field 1012 includes one first window 1013 for the user to input a color of skin or color of clothes of the human, a second window 1014 for the user to input the height of the human, and a third window 1015 for the user to input one or more body features of the human.

The key image obtaining module 20 includes various software components and/or sets of instructions, which may be implemented by the processor 201 to build a model image as the key image according to the input parameters if the user inputs are parameters, or obtain an uploaded image as the key image if the user input is an image. For example, if a user wants to search for video files related to a famous person from a plurality of video files stored in a local or remote database and the user already has a picture of the famous person, the user can upload a picture of the famous person through the image input field 1011 as the key image for finding videos related to the famous person. If the user wants to find video files for a lost child, from videos recorded by cameras arranged on a street, but the user has no picture of the child, the user can input characteristic parameters of the child through the parameter input field 1012, such as the height of the child (say 120 centimeters), the jacket color of the child (say red and blue), and the like, the key image obtaining module 20 may build a model image of the child according to the parameters the user inputs, as the key image for video searching.

The extracting module 30 includes various software components and/or sets of instructions, which may be implemented by the processor 201 to extract information as to particular features of the obtained key image. In this embodiment, the particular features of the key image may include the colors of the pixels, the outline of a human figure, text features of the image, for example written descriptions of the image, and the like. Known recognition technology is employed by the analyzing module 20 to extract the features of the key image.

The searching module 40 includes various software components and/or sets of instructions, which may be implemented by the processor 201 to compare the features of the key image with features from each frame of each video file stored in a local or remote database, and determine that a video file is a target video file if features of at least one frame of the video file substantially matches with the one or more features of the key image. In this embodiment, the searching module 40 determines that the features shown in a single frame of one stored video file matches with the features of the key image if a degree of correlation between the features of the key image and the features shown in the frame of the one stored video file reaches a predetermined value, such as 70%.

The target video file processing module 50 includes various software components and/or sets of instructions, which may be implemented by the processor 201 to present the target video files for display or other processing. In this embodiment, the target video file processing module 50 is implemented by the processor 201 to present the target video files by displaying a list of the target video files or by displaying a list of links to the target video files on the display unit 203. In an alternative embodiment, the target video file processing module 50 is firstly implemented by the processor 201 to obtain the frames of the target video file matching with the features of the key image, and to display the obtained frames or to display links to the obtained frames on the display unit 203.

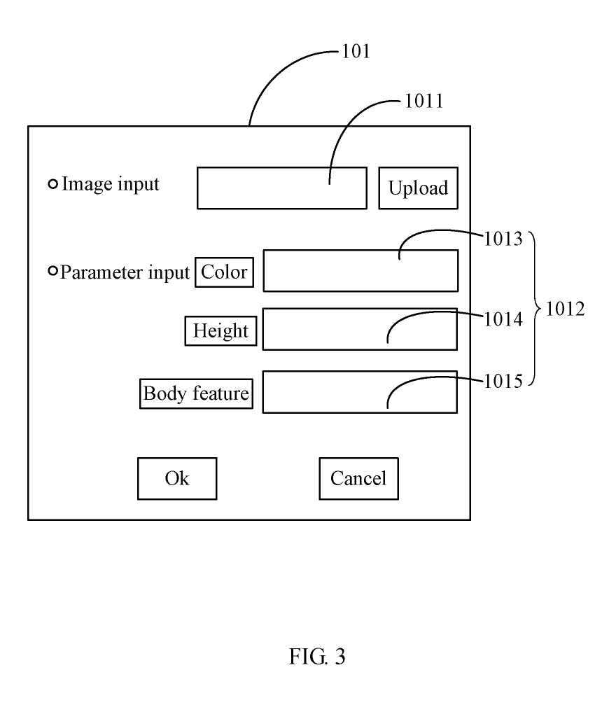

FIG. 3 is a flowchart of a video search method, in accordance with an exemplary embodiment.

In step S401, the input interface generating module 10 is implemented by the processor 201 to display an input interface 101 on the display unit 203. The interface 101 includes an image input field 1011 and a parameter input field 1012. The image input field 1011 enables a user to upload an image as a key image for video files searching. The parameter input field 1012 enables the user to input parameters used in building a key image.

In step S402, the key image obtaining module 20 is implemented by the processor 201 to build a model image as the key image according to the input parameters if the user inputs are parameters, or to obtain an uploaded image as the key image if the user input is an image.

In step S403, the extracting module 30 is implemented by the processor 201 to extract information as to the particular features of the obtained key image.

In step S404, the searching module 40 is implemented by the processor 201 to compare the features of the key image with features shown in each frame of each video file stored in a local or remote database, and to determine that a video file is a target video file if features of at least one frame of the video file substantially matches with the features of the key image.

In step S405, the target video file processing module 50 is implemented by the processor 201 to present the target video files for display or other processing.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A computer-based method for video files searching comprising:
displaying an input interface;
building a model image as a key image according to at least one input parameter input through the input interface;
extracting information as to particular features of the key image;
comparing the features of the key image with features from each frame of each of stored video files;
determining a video file is a target video file if features of at least one frame of the video file matches with the one or more features of the key image; and
presenting the target video files.

2. The method as described in claim 1, wherein the step of presenting the target video files comprises:
presenting the target video files by displaying a list of the target video files or by displaying a list of links to the target video file.

3. The method as described in claim 1, wherein the step of presenting the target video files comprises:
obtaining the frames of a target video file matching with the features of the key image; and
displaying the obtained frames or to displaying links to the obtained frames.

4. A computing device for video searching, comprising:
a storage unit device;
a display unit;
at least one processor; and
a video search system comprising computerized code in the form of one or more programs, which are stored in the storage device and executable by the at least one processor, the one or more programs comprising:
an input interface generating module operable to displaying an input interface on the display unit, wherein the input interface comprises at least a parameter input field, the parameter input field is configured for a user to input parameters used in building a key image;
a key image obtaining module operable to obtain the input parameters and build a model image as a key image according to the input parameters if determining that parameters are input;
an extracting module operable to extract information as to particular features of the key image;
a searching module operable to compare the features of the key image with features shown in each frame of each stored video file, and determine a video file is a target video file if features of at least one frame of the video file matches with the features of the key image; and
a target video file processing module operable to present the target video files.

5. The computing device as described in claim 4, wherein the input interface further comprises an image input field, the image input field is configured for the user to input images, and the key image obtaining module determines an uploaded image as the key image if determining that the images are input.

6. The computing device as described in claim 4, wherein the parameter input field comprises a number of windows for the user to input different parameters.

7. The computing device as described in claim 4, wherein the target video file processing module is implemented by the processor to present the target video files by displaying a list of the target video files or displaying a list of links to the target video files on the display unit.

8. The computing device as described in claim 4, wherein the target video file processing module is firstly implemented by the processor to obtain the frames of a target video file matching with the features of the key image; and to display the obtained frames or to display links of the obtained frames.

9. A storage medium storing a plurality of modules, the plurality of modules comprising instructions executable by a processor of a computing device to search video files, the video file search method comprising:
displaying an input interface;
building a model image as the key image according to at least one input parameters if at least one parameter is input through the input interface;
extracting information as to particular features of the key image;
comparing the features of the key image with features shown in each frame of each of stored video files to determine whether the features of one or more frames of each of the stored video files match with the features of the key images;
determining that a video file is a target video file if features of at least one frame of the video file matches with the features of the key image; and
presenting the target video files.

10. The storage medium as described in claim 9, wherein the step of presenting the target video files comprises:
presenting the target video files by displaying a list of the target video files or displaying a list of links to the target video file.

11. The storage medium as described in claim 9, wherein the step of presenting the target video files comprises:
obtaining the frames of a target video file matching with the features of the key image; and
displaying the obtained frames or displaying links to the obtained frames.
